(19) United States
(12) Patent Application Publication
(10) Pub. No.: US 2005/0225791 A1
(43) Pub. Date: Oct. 13, 2005

(54) Security server for facsimile machine and method of selectively printing document data using the security server

(75) Inventor: Gun-il Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/764,483

(22) Filed: Jan. 27, 2004

(30) Foreign Application Priority Data
Jan. 27, 2003 (KR) 2003-5193

(51) Int. Cl. G06F 3/12; G08B 29/00; H04N 1/32; G06F 7/04; H04L 9/32

(52) U.S. Cl. 358/1.14; 358/400; 358/468; 340/5.2; 340/5.85

(57) ABSTRACT

A security server for facsimile machines to provide security information on users authorized to print document data transmitted from a transmitting facsimile machine to a receiving facsimile machine, to the receiving facsimile machine. The security server includes a security information storage to store the security information, a security server control to receive the security information from the receiving facsimile machine and to update the received security information into the security server control An interface controlled by the security server control transmits the updated security information to the receiving facsimile machine, in response to a request issued by the receiving facsimile machine via a security communication line different from a communication line that transmits the document data from the transmitting facsimile machine to the receiving facsimile machine. The security information includes identifications and passwords of the authorized users. Accordingly, it is possible to transmit or receive a document while transmitting or receiving security information and to make a plurality of receiving facsimile machines that use different protocols share the security information.

CROSS-REFERENCE TO RELATED APPLICATIONS benefit of Korean Patent Application No. 2003-5193, filed on Jan. 27, 2003, in the Korean Intellectual Property Office, the disclosure of which is incorporated herein by reference.

### BACKGROUND OF THE INVENTION

1. Field of the Invention

The present invention relates to a facsimile machine, and more particularly, to a security server for facsimile machines and a method of selectively printing document data using the security server.

2. Description of the Related Art

Unlike telephones that transmit and receive voice data, facsimile machines transmit or receive document data through a connection to a public switched telephone network (PSTN) and print the received document data. Therefore, facsimile machines are widely used for various purposes including business and domestic.

In a typical facsimile system, a transmitting facsimile machine scans a document and transmits document data, obtained as a result of the scanning, to a receiving facsimile machine via a PSTN. The receiving facsimile machine receives the document data from the transmitting facsimile machine and prints the received document data. If there is a need for security of the document data, a security function that allows only an authorized user to view and print the document data is necessary. For example, in transmitting an official document requested by a client to the client's facsimile machine, the official document is preferably made available only to the requesting client since there is a possibility that the official document contains personal information. Therefore, a conventional facsimile machine having a security function so that only authorized users can print selected document data has been developed.

FIG. 1 is a block diagram of a facsimile machine that performs a conventional method of selectively printing document data. Referring to FIG. 1, a user inputs document data into a transmitting facsimile machine by scanning a document using a scanner installed in the transmitting facsimile machine. Thereafter, the user inputs security information regarding authorized users, such as the authorized users' identifications (IDs) and passwords, into the transmitting facsimile machine. Then, the transmitting facsimile machine transmits the scanned document data and the inputted security information to a receiving facsimile machine via a PSTN.

When the document data is received, the receiving facsimile machine may also receive an ID and password from an unauthorized user to attempt to print the document data. An authentication of the unauthorized user is attempted by comparing the received ID and the received password with the security information. The document data is not printed if the user is not authenticated.

The authentication of the unauthorized user may be attempted without transmitting the security information from the transmitting facsimile machine to the receiving facsimile machine along with the document data, by receiving users' IDs and passwords and comparing the user's ID and password with previously stored IDs and passwords.

However, the conventional methods and machines for selectively printing document data have many disadvantages. For example, if users need or desire to use a plurality of receiving facsimile machines, each of the receiving facsimile machines is individually required to update security information on authorized users that are authorized to print document data. That is, security information needs to be synchronized with each of the receiving facsimile machines. In addition, in order to transmit the security information between facsimile machines, the facsimile machines are required to use the same protocol, and possibly be manufactured by the same manufacturer.

Methods and machines are required that enable a receiving facsimile machine to easily update security information on authorized users.

### SUMMARY OF THE INVENTION

According to an aspect of the present invention a security server for facsimile machines is provided that stores security information on users authorized to print document data out for a plurality of receiving facsimile machines, and a method of easily updating the security information.

According to an aspect of the present invention a method is provided of authenticating an authorized user who is authorized to print document data even where transmitting and receiving facsimile machines have different protocols and/or different manufacturers.

According to an aspect of the present invention a method is provided of transmitting security information from a security server for facsimile machines to a receiving facsimile machine and transmitting document data from a transmitting facsimile machine to the receiving facsimile machine.

According to an aspect of the present invention, a security server for facsimile machines provides security information on users who are authorized to print document data, the security information transmitted from a transmitting facsimile machine to a receiving facsimile machine, to the receiving facsimile machine. The security server includes a security information storage unit to store the security information and a security server control unit, which receives the security information from the receiving facsimile machine and updates the received security information to the security server control unit. The security server also includes an interface unit, which is controlled by the security server control unit, the interface unit transmitting the updated security information to the receiving facsimile machine, in response to a request issued by the receiving facsimile machine, via a security communication line that is different from a communication line used to transmit the document data from the transmitting facsimile machine to the receiving facsimile machine.

According to an aspect of the present invention, the security information includes at least identifications and passwords of the authorized users. The security server control unit, upon receiving user information input by an unauthorized user attempting to print the document data from the receiving facsimile machine, determines whether to authenticate the unauthorized user or not based on a result of comparing the received user information with the security information stored in the security information storage unit, and informs the receiving facsimile machine of a result of the determination.

According to an aspect of the present invention, the security server control unit transmits the security information stored in the security information storage unit to the transmitting facsimile machine via the receiving facsimile machine, and then the transmitting facsimile machine determines whether to authenticate the unauthorized user or not based on a result of comparing the user information received from the receiving facsimile machine with the received security information.

According to an aspect of the present invention, the security server control unit transmits the security information stored in the security information storage unit to the receiving facsimile machine, and then the receiving facsimile machine determines whether to authenticate the unauthorized user or not based on a result of comparing user information, input by an unauthorized user attempting to print the document data, with the received security information.

According to another aspect of the present invention, a method of selectively printing document data is provided using a security server for facsimile machines providing security information on users authorized to print document data, which is transmitted from a transmitting facsimile machine to a receiving facsimile machine, to the receiving facsimile machine. The method includes storing the security information, transmitting the security information and the document data to the receiving facsimile machine, receiving user information on an unauthorized user who attempts to print the document data, determining whether to authenticate the unauthorized user or not based on a result of comparing the received user information with the security information, and printing the document data if the unauthorized user is authenticated. The security information is transmitted via a different security communication line from a communication line through which the document data is transmitted from the transmitting facsimile machine to the receiving facsimile machine.

According to an aspect of the present invention, the security information includes at least identifications and passwords of the authorized users.

According to an aspect of the present invention, the determining whether to authenticate the unauthorized user or not based on a result of comparing the received user information with the security information includes providing the received user information to the security server for facsimile machines, and enabling the security server for facsimile machines to determine whether to authenticate the unauthorized user or not based on a result of comparing the received user information with the security information and to inform the receiving facsimile machine of a result of the determination.

According to an aspect of the present invention, the determining whether to authenticate the unauthorized user or not based on a result of comparing the received user information with the security information includes providing the received user information to the transmitting facsimile machine and enabling the transmitting facsimile machine to determine whether to authenticate the unauthorized user or not based on a result of comparing the received user information with the security information and to inform the receiving facsimile machine of a result of the determination.

According to an aspect of the present invention, the determining whether to authenticate the unauthorized user or not based on a result of comparing the received user information with the security information includes providing the received user information to the receiving facsimile machine, and enabling the receiving facsimile machine to determine whether to authenticate the unauthorized user or not based on a result of comparing the received user information with the security information and to inform the receiving facsimile machine of a result of the determination.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments taken in conjunction with the accompanying drawings in which:

FIG. 1 is a block diagram of a facsimile machine that uses a conventional method of selectively printing document data;

FIG. 2 is a block diagram of a facsimile system for illustrating the operation of a facsimile security server for facsimile machines, according to an aspect of the present invention;

FIG. 3 is a detailed block diagram illustrating the operation of the facsimile system of FIG. 2; and

FIG. 4 is a flowchart illustrating a method of selectively printing document data according to an aspect of the present invention.

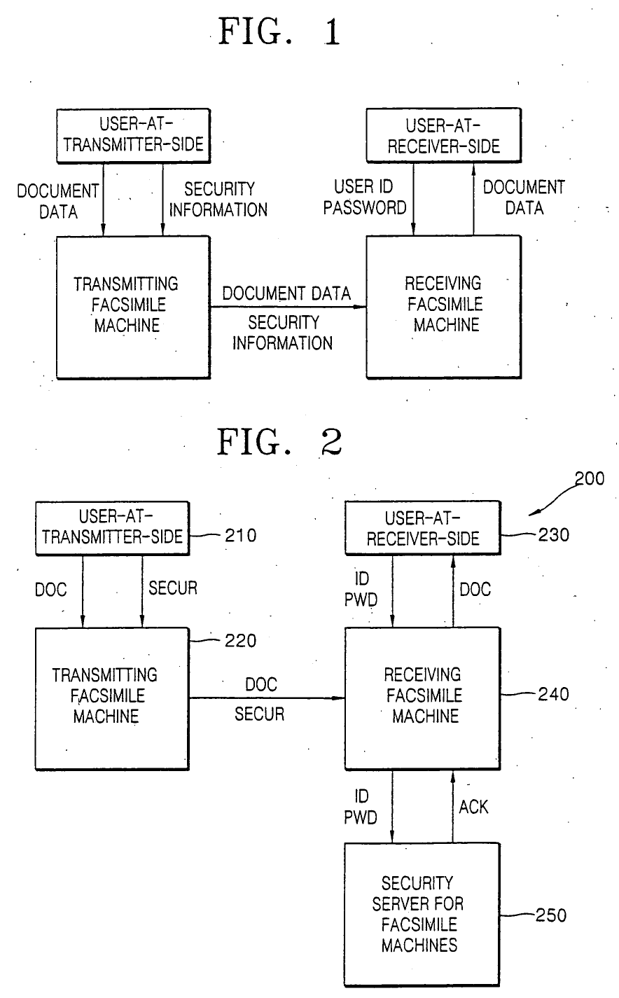

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a block diagram of a facsimile system 200, for illustrating the operation of a security server for facsimile machines according to an aspect of the present invention. Referring to FIG. 2, the facsimile system 200 includes a transmitting facsimile machine 220, a receiving facsimile machine 240, a user-at-transmitter-side 210, a user-at-receiver-side 230, and a security server 250 for facsimile machines. The operation of the facsimile system 200 is described in the following paragraphs with reference to FIG. 2.

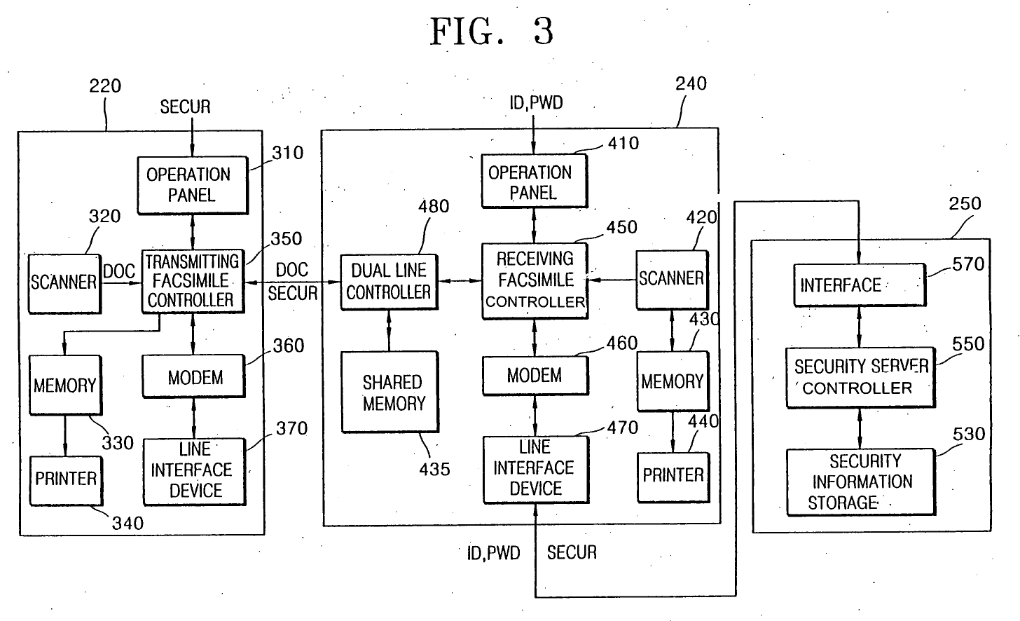

The user-at-transmitter-side 210 inputs security information SECUR on authorized users, who are authorized to print document data DOC to be transmitted to the transmitting facsimile machine 220, into the transmitting facsimile machine 220. The document data DOC is input into the transmitting facsimile machine 220 via a scanner (not shown) installed in the transmitting facsimile machine 220, and the security information SECUR is input into the transmitting facsimile machine 220 via an operation panel (not shown) installed in the transmitting facsimile machine 220. A detailed explanation of the structure of the transmitting facsimile machine 220 with reference to FIG. 3 is presented later.

The transmitting facsimile machine 220 receives, from the user-at-receiver-side 210, a phone number of the receiving facsimile machine 240 that is to receive the document data DOC, and calls the receiving facsimile machine 240 at the receiving phone number. If the receiving facsimile machine 240 responds to the call made by the transmitting facsimile machine 220, a communication channel is opened between the transmitting facsimile machine 220 and the receiving facsimile machine 240. The document data DOC and the security information SECUR are transmitted from the transmitting facsimile machine 220 to the receiving facsimile machine 240.

If the document data DOC and the security information SECUR are successfully received from the transmitting facsimile machine 220, the receiving facsimile machine 240 transmits the security information SECUR to the security server 250 for the facsimile machines. The security server 250 for facsimile machines having already stored security information including authorized users' IDs and passwords, updates the previously stored security information SECUR based on the security information SECUR received from the receiving facsimile machine 240.

In order to print the document data DOC received from the transmitting facsimile machine 220, the user-at-receiver-side 230 inputs their ID and password (PWD) into the receiving facsimile machine 240. Then, the receiving facsimile machine 240 transmits the user-at-receiver-side 230's ID and password (PWD) to the security server 250 for the facsimile machines. The security server 250 for the facsimile machines compares the received ID and received password (PWD) with the security information previously stored therein and transmits an acknowledgement signal (ACK) to the receiving facsimile machine 240 upon finding a match for the received ID and the received password (PWD) in the security information stored in the security server 250 for the facsimile machines. The acknowledgement signal (ACK) informs the receiving facsimile machine 240 that the user-at-receiver-side 230 is successfully authenticated. Thus, in response to the acknowledgement signal (ACK), the receiving facsimile machine 240 prints the document data DOC.

In the facsimile system 200, security information on authorized users is stored in the security server 250 for the facsimile machines. The receiving facsimile machine 240 only transmits an ID and password of a user attempting to print the document data DOC to the security server 250 for facsimile machines. The receiving facsimile machine 240 is informed at a later time whether the user has been successfully authenticated. Therefore, if the security information stored in the security server 250 for the facsimile machines is updated, all receiving facsimile machines that communicate with the security server 250 for facsimile machines access the updated security information. In addition, there is no need for the transmitting facsimile machine 220 and the receiving facsimile machine 240 to use the same protocol. Any protocol is used for the transmitting facsimile machine 220 and the receiving facsimile machine 240 as long as the protocol enables the security information to be transmitted between the receiving facsimile machine 240 and the security server 250 for the facsimile machines. Therefore, compatibility restrictions on an expansion of the facsimile system 200 are removed.

The security server 250 for facsimile machines communicates with the receiving facsimile machine 240 via a communication channel that is different from a communication channel that the transmitting facsimile machine 220 communicates with the receiving facsimile machine 240. In other words, the security server 250 for the facsimile machines may communicate with the receiving facsimile machine 240 using a dual communication line. With the dual line, the receiving facsimile machine 240 receives the document data DOC from the transmitting facsimile machine 220 while communicating with the security server 250 for the facsimile machines. Therefore, regardless of whether the document data DOC is received, the receiving facsimile machine 240 receives an ID and password from the user-at-receiver-side 230 and receives the acknowledgement signal (ACK) from the security server 250 for the facsimile machines. Although only a dual line is described, aspects of the present invention are not limited to such and may include a multiple line for multiple communication channels.

The facsimile system 200 of FIG. 2 is an example of an aspect of the present invention, and thus the present invention should not be construed as being limited to the illustrated aspect. For example, according to an aspect of the present invention security information SECUR is input into the transmitting facsimile machine 220 by the user-at-transmitter-side 210 and is eventually stored in the security server 250 for the facsimile machines via the receiving facsimile machine 240. The security information SECUR is stored in the security server 250 for facsimile machines or alternatively input by the user-at-receiver-side 230. According to aspects of the present invention, security information is managed for authorized users using the security server 250 for the facsimile machines.

According to an aspect of the present invention, security information on authorized users and the user-at-receiver-side 230's ID and password are transmitted to the security server 250 for the facsimile machines, and then the security server 250 determines whether to authenticate the user-at-receiver-side 230. However, the security server 250 for facsimile machines alternatively stores only the security information on authorized users and provides requested pieces of security information to the transmitting facsimile machine 220 or the receiving facsimile machine 240 in response to a call made by the transmitting facsimile machine 220 or the receiving facsimile machine 240 so that the transmitting facsimile machine 220 or the receiving facsimile machine 240 determines whether to authenticate the user-at-transmitter-side 210 or the user-at-receiver-side 220. If the security server 250 for the facsimile machines is manufactured so as to perform the authentication of a user, the structure of the transmitting facsimile machine 220 and the receiving facsimile machine 240 is simplified.

FIG. 3 is a block diagram illustrating an example operation of the facsimile system 200 of FIG. 2. Referring to FIG. 3, the transmitting facsimile machine 220 includes an operation panel 310, a scanner 320, a memory 330, a printer 340, a transmitting facsimile controller 350, a modem 360, and a line interface device 370. The receiving facsimile machine 240 includes an operation panel 410, a scanner 420, a memory 430, a shared memory 435, a printer 440, a receiving facsimile controller 450, a modem 460, a line interface device 470, and a dual line controller 480. Although a dual line controller is described, the controller is not limited to controlling two lines, and may additional lines.

The security server 250 for the facsimile machines includes a security information storage 530, a security server controller 550, and an interface 470. The transmitting facsimile controller 350 controls the operation of the transmitting facsimile machine 220 according to a control program stored in the memory 330. In other words, by using the operation panel 310, the user-at-transmitter-side 210 monitors the operation of the transmitting facsimile machine 220 and inputs a phone number of a destination facsimile machine, to which document data is to be transmitted, and the security information SECUR on authorized users into the transmitting facsimile machine 220. The modem 360 is connected between the transmitting facsimile controller 350 and the line interface device 370. The line interface device 370 is a terminal to which a telephone line is connected. The modem 360 receives or transmits data via the line interface device 370. The printer 340 is installed in the transmitting facsimile machine 220 so the transmitting facsimile machine 220 serves as a receiving party that receives document data from another facsimile machine as well as a transmitting party that transmits document data to another facsimile machine.

When the transmitting facsimile machine serves as a receiving party, the transmitting facsimile machine 220 prints document data received from another facsimile machine using the printer 340. The printer 340 prints information on an operating state of the transmitting facsimile machine 220 in response to a user's request. The operation panel 310 includes a key matrix including functional keys for setting a variety of functions provided by the transmitting facsimile machine 220, and a display window to display the operating state of the transmitting facsimile machine 220. Key inputs using the operation panel 310 are transmitted to the transmitting facsimile controller 350. The scanner 320 scans a document to be transmitted under control of the transmitting facsimile controller 350 and thus generates the document data DOC. The document data DOC is stored in the memory 330. The memory 330 stores a control program to drive the transmitting facsimile controller 350 or document data received from another facsimile machine when the transmitting facsimile machine 220 operates in a data receiving mode. In addition, the memory 330 temporarily stores a variety of data obtained as a result of the operation of the transmitting facsimile machine 220.

The scanned document data DOC and the security information SECUR received from the user-at-transmitter-side 210 are transmitted to the receiving facsimile machine 240 via the modem 360 under control of the transmitting facsimile controller 350.

The operation and structure of the operation panel 410, the scanner 420, the memory 430, the printer 440, the transmitting facsimile controller 450, the modem 460, and the line interface device 470 of the receiving facsimile machine 240 are similar to the operation and structure of their respective counterparts of the transmitting facsimile machine 220, and thus their descriptions will not be repeated.

The dual line controller 480 of the receiving facsimile machine 240 uses the shared memory 435 to control communications via a communication line between the receiving facsimile machine 240 and the transmitting facsimile machine 220, and communications via a security communication line between the receiving facsimile machine 240 and the security server 250 for facsimile machines. The shared memory 435 temporarily stores data transmitted between the transmitting facsimile machine 220 and the receiving facsimile machine 240 and stores information on operating states of the transmitting and receiving facsimile machines 220 and 240.

The security server 250 for facsimile machines includes the security information storage unit 530, the security sever controller 550, and the interface 570. The security information storage unit 530 stores the security information SECUR on authorized users, input into the receiving facsimile machine 240 or the transmitting facsimile machine 220 using the operation panel 310 or 410. In addition, the security information storage unit 530 updates the stored security information SECUR based on user inputs. The security server controller 550 determines whether to authenticate a user attempting to print the document data based on a result of comparing the user's ID and password with the security information stored in the security information storage unit 530 and informs the receiving facsimile machine 240 of a result of the determination. The interface 570, which is controlled by the security server controller 550, transmits the updated security information or information indicating whether the user has been authenticated to the receiving facsimile machine 240.

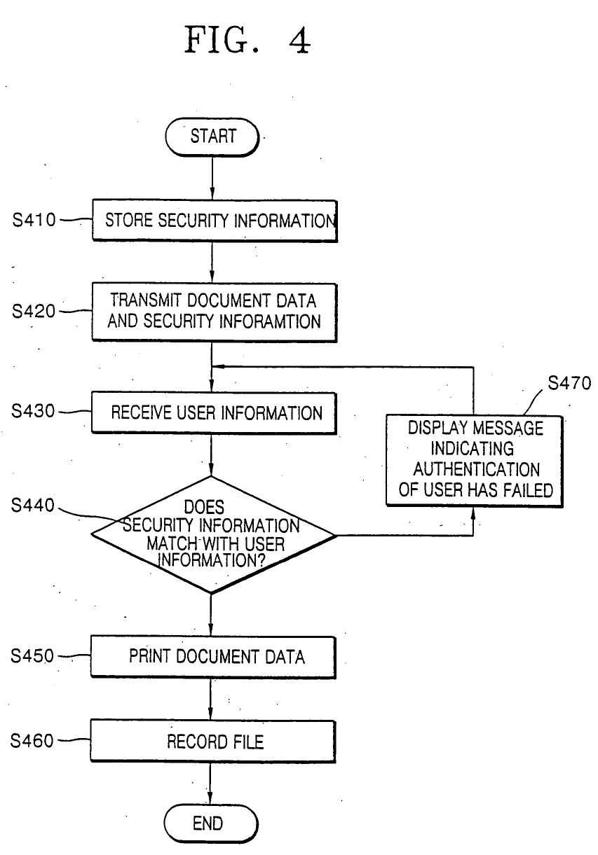

FIG. 4 is a flowchart illustrating a method of selectively printing document data according to an aspect of the present invention. Referring to FIG. 4, security information on users, who are authorized to print document data, is stored in operation S410. The security information is used for determining whether a user who attempts to print the document data is an authorized user and is stored in a security information storage unit of a security server for facsimile machines.

Once the security information is stored, a transmitting facsimile machine scans the document data and transmits the scanned document data to a receiving facsimile machine in operation S420. If the security information has been updated or a new piece of security information has been added to the security information, the transmitting facsimile machine transmits the updated security information or the newly added piece of security information to the receiving facsimile machine together with the document data in operation S420.

When the receiving facsimile machine receives the document data and the security information from the transmitting facsimile machine, the receiving facsimile machine receives user information, such as an ID and a password, from the user who attempts to print the document data, in operation S430. As described above, the user information is input by the user using an operation panel installed in the receiving facsimile machine.

Upon receiving the user information, it is determined in operation S440 whether the received user information matches the security information that was stored in operation S410. Upon matching the received user information, the user is determined to be an authorized user. Therefore, the document data is printed in operation S450.

According to an aspect of the present invention, the user information is recorded in a file. A record of user information assists in prevention of download of important document data initiated by an unauthorized user. Since the file shows a list of all users who have ever printed the document data, a higher security is guaranteed.

If a match is not found for the received user information with the security information stored in operation S410, the user attempting to print the document data is determined to be an unauthorized user. A message indicating that the user's request for printing the document data is denied is printed in operation S470. Thereafter, the user is required again to input his/her information. A detailed description of operation S440 is presented in the following paragraphs.

As described above, the security server for facsimile machines receives information on a user yet to be authenticated, compares the received information with the security information previously stored therein, and determines whether to authenticate the user based on the comparison result. If the security server for facsimile machines is manufactured to perform the authentication of a user, the structure of the transmitting and receiving facsimile machines are simplified because the transmitting and receiving facsimile machines do not perform the authentication of the user, but simply print the document data in response to the determination result provided by the security server for the facsimile machines.

Alternatively, the security information stored in the security server for the facsimile machines and the user information input into the receiving facsimile machine may be transmitted to the transmitting facsimile machine, and then the transmitting facsimile machine determines whether to authenticate the user who attempts to print the document data. The receiving facsimile machine selectively prints the document data based on the authentication result provided by the transmitting facsimile machine.

Alternatively, the security information previously stored in the security server for facsimile machines is transmitted to the receiving facsimile machine, and then the receiving facsimile machine determines whether to authenticate the user attempting to print the document data. The time taken to authenticate the user is considerably reduced because it is possible for the receiving facsimile machine to perform the authentication of the user without the need to transmit the received user information to the transmitting facsimile machine or the security server for the facsimile machines.

As described above, according to an aspect of the present invention communications between the receiving facsimile machine and the transmitting facsimile machine are carried out using a separate security communication line while transmitting the document data between the transmitting facsimile machine and the receiving facsimile machine.

According to an aspect of the present invention, it is possible to easily update security information on authorized users by using a security server for the facsimile machines.

In addition, authorized users are authenticated to print predetermined document data even when transmitting and receiving facsimile machines do not share the same manufacturer or the same protocol.

Furthermore, the receiving facsimile machine receives the document data from the transmitting facsimile machine while communicating with the security server for facsimile machines.

Although a few embodiments of the present invention have been shown and described, it would be appreciated by those skilled in the art that changes may be made in this embodiment without departing from the principles and spirit of the invention, the scope of which is defined in the claims and their equivalents.

1. A security server for facsimile machines, which provides security information on users who are authorized to print document data transmitted from a transmitting facsimile machine to a receiving facsimile machine, to the receiving facsimile machine, the security server comprising:
a security information storage to store the security information;
a security server controller to receive the security information from the receiving facsimile machine and to update the received security information to the security server controller; and
an interface controlled by the security server controller to transmit the updated security information to the receiving facsimile machine, in response to a request issued by the receiving facsimile machine via a security communication line that is different from a communication line that transmits the document data from the transmitting facsimile machine to the receiving facsimile machine.

2. The security server of claim 1, wherein the security information includes at least a plurality of identifications and passwords of the authorized users.

3. The security server of claim 2, wherein the security server control unit receives user information input by a user attempting to print the document data, from the receiving facsimile machine, determines whether to authenticate the user based on a result of comparing the received user information with the security information stored in the security information storage unit, and informs the receiving facsimile machine of a result of the determination.

4. The security server of claim 2, wherein the security server control unit transmits the security information stored in the security information storage unit to the transmitting facsimile machine via the receiving facsimile machine, and the transmitting facsimile machine determines whether to authenticate the user or based on a result of comparing the user information received from the receiving facsimile machine with the received security information.

5. The security server of claim 2, wherein the security server control unit transmits the security information stored in the security information storage unit to the receiving facsimile machine, and the receiving facsimile machine determines whether to authenticate the unauthorized user based on a result of comparing user information input by a user attempting to print the document data, with the received security information.

6. A method of selectively printing document data using a security server for facsimile machines, which provides security information on users who are authorized to print document data transmitted from a transmitting facsimile machine to a receiving facsimile machine, to the receiving facsimile machine, the method comprising:
storing the security information;
transmitting the security information and the document data to the receiving facsimile machine;
receiving user information on a user attempting to print the document data;
authenticating the user based on a result of comparing the received user information with the security information; and
printing the document data if the user is authenticated,
wherein the security information is transmitted via a security communication line different from a communication line that transmits the document data from the transmitting facsimile machine to the receiving facsimile machine.

7. The method of claim 6, wherein the security information includes at least a plurality of identifications and passwords of the authorized users.

8. The method of claim 7, wherein the authenticating the user based on a result of comparing the received user information with the security information comprises:
providing the received user information to the security server for the facsimile machines; and
enabling the security server for the facsimile machines to determine whether to authenticate the unauthorized user based on a result of comparing the received user information with the security information and to inform the receiving facsimile machine of a result of the determination.

9. The method of claim 7, wherein the authenticating the user based on a result of comparing the received user information with the security information comprises:
providing the received user information to the transmitting facsimile machine; and
enabling the transmitting facsimile machine to determine whether to authenticate the unauthorized user or not based on a result of comparing the received user information with the security information and to inform the receiving facsimile machine of a result of the determination.

10. The method of claim 7, wherein the authenticating the user based on a result of comparing the received user information with the security information comprises:
providing the received user information to the receiving facsimile machine; and
enabling the receiving facsimile machine to determine whether to authenticate the unauthorized user or not based on a result of comparing the received user information with the security information and to inform the receiving facsimile machine of a result of the determination.

11. A computer-readable medium encoded with processing instructions implementing a method of selectively printing document data using a security server for facsimile machines, which provides security information on users who are authorized to print document data transmitted from a transmitting facsimile machine to a receiving facsimile machine, to the receiving facsimile machine, the method comprising:
storing the security information;
transmitting the security information and the document data to the receiving facsimile machine;
receiving user information on a user attempting to print the document data;
authenticating the user based on a result of comparing the received user information with the security information; and
printing the document data if the user is authenticated,
wherein the security information is transmitted via a security communication line different from a communication line that transmits the document data from the transmitting facsimile machine to the receiving facsimile machine.

12. The computer-readable medium encoded with processing instructions implementing a method of selectively printing document data method according to claim 11, wherein the authenticating the user based on a result of comparing the received user information with the security information comprises:
providing the received user information to the security server for the facsimile machine; and
enabling the security server for the facsimile machines to determine whether to authenticate the unauthorized user based on a result of comparing the received user information with the security information and to inform the receiving facsimile machine of a result of the determination.

13. The computer-readable medium encoded with processing instructions implementing a method of selectively printing document data method according to claim 11, wherein the authenticating the user based on a result of comparing the received user information with the security information comprises:
providing the received user information to the transmitting facsimile machine; and
enabling the transmitting facsimile machine to determine whether to authenticate the unauthorized user or not based on a result of comparing the received user information with the security information and to inform the receiving facsimile machine of a result of the determination.

14. The computer-readable medium encoded with processing instructions implementing a method of selectively printing document data method according to claim 11,
wherein the authenticating the user based on a result of comparing the received user information with the security information comprises:
providing the received user information to the receiving facsimile machine; and
enabling the receiving facsimile machine to determine whether to authenticate the unauthorized user or not based on a result of comparing the received user information with the security information and to inform the receiving facsimile machine of a result of the determination.

15. A facsimile system for a plurality of facsimile machines, comprising:
a transmitting facsimile machine to accept inputs of document data and security information;
a receiving facsimile machine to receive the document data and the security information from the transmitting facsimile machine; and
wherein one of the security server, the transmitting facsimile machine, and the receiving facsimile machine compare the stored security information with user information to authenticate the user.

16. The facsimile system according to claim 15, further comprising:
a first communication line to transmit the user information; and
a second communication line to transmit the document data,
wherein upon an update of the security information, the transmitting facsimile machine transmits the updated security information to the receiving facsimile machine together with the document data.

17. A method of authenticating users for a facsimile system, comprising:
transmitting an identification of a receiving facsimile machine to receive document data;
opening a first communication channel between a transmitting facsimile machine and the receiving facsimile machine;
transmitting the document data on the first communication channel from the transmitting facsimile machine to the receiving facsimile machine;
transmitting information on a user from the receiving facsimile machine to a security server;
comparing the received user information with security information;
authenticating the user upon the user information matching the security information to provide an acknowledgement to the receiving facsimile machine; and
providing the document data to the user on receiving the acknowledgment.

18. The method according to claim 17, further comprising:
prestoring the security information in the security server;
transmitting updated security information from the transmitting facsimile machine to the security server; and
transmitting stored security information requested by the receiving facsimile machine or the transmitting facsimile machine.

19. A facsimile machine to connect with a security server, comprising:
an operation panel to input user information and request document data;
a multiple line controller to control at least a first communication line to receive security information and a second communication line to receive the document data;
at least one of a receiving controller and a transmitting controller to control an input and output of data and information; and
a line interface to interface with the security server to forward the inputted user information.

20. The facsimile machine according to claim 19, further comprising:
at least one of a scanner to input document data and a printer to output document data;
a shared memory to temporarily store received document data; and
a memory to store a control program to control the facsimile machine.

21. The facsimile machine according to claim 19, wherein the user information is at least one of a user identification and a password, a user monitors operation of the facsimile machine at the operation panel, and the facsimile machine has a same communication protocol as the security server.
